(19) United States
(12) Patent Application Publication
(10) Pub. No.: US 2023/0100313 A1
(43) Pub. Date: Mar. 30, 2023

(54) METHODS AND SYSTEMS FOR MULTI-DIMENSION ELECTRIC VEHICLE CHARGING MANAGEMENT

(71) Applicant: Noodoe Corporation, Taipei City (TW)

(72) Inventors: Yu-Ting LIOU, Taipei City (TW); En-Yu SHIH, Taipei City (TW); Yi-An HOU, Taipei City (TW); Chun-Hung KUNG, Taipei City (TW)

(21) Appl. No.: 17/956,888

(22) Filed: Sep. 30, 2022

(30) Foreign Application Priority Data
Sep. 30, 2021 (TW) 110136377

(51) Int. Cl. G06Q 10/02; B60L 53/67; B60L 53/66; G06Q 30/04

(52) U.S. Cl. CPC G06Q 10/02; B60L 53/67; B60L 53/665; G06Q 30/04

(57) ABSTRACT

Methods and systems for multi-dimension electric vehicle charging management are provided. First, configuration setting data corresponding to each electric vehicle charging station is provided. A service application instruction corresponding to a specific electric vehicle charging station, at least including specific user identity data corresponding to a specific user, is received from the specific electric vehicle charging station or a mobile device through a network. In response to the service application instruction, a specific user category is determined based on the specific user identity data. Then, the configuration setting data of the specific electric vehicle charging station is obtained, and it is determined whether the specific user can use or make a reservation to use a specific electric vehicle charging station at a receiving time according to the receiving time, the specific user category, and the configuration setting data of the specific electric vehicle charging station.

### BACKGROUND OF THE INVENTION

### Field of the Invention

The disclosure relates generally to methods and systems for electric vehicle charging station management, and, more particularly to methods and systems for multi-dimension electric vehicle charging station management that can satisfy both user requirements and charging point operator requirements.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

In some charging fields, common electric vehicle charging stations are usually set to allow electric vehicle users in the charging field to perform electric vehicle charging operations. The manager of the charging field or the operator of the electric vehicle charging station can perform the charging operation of the corresponding charging operation at a charging rate after each charging operation is completed to collect the corresponding charging fee. Generally, the charging rate of the charging field can be set according to the conditions of each field, such as the location of the charging field, the peak or off-peak period, or the electric vehicle charging station operator of the corresponding field. Through the charging rate setting, the utilization rate of electric vehicle charging stations can be increased. For example, through different peak or off-peak charging rates, lower charging rates can be used to attract electric vehicle owners to charge during off-peak hours, thereby increasing the utilization rate of the charging field during off-peak hours. On the other hand, an electric vehicle user can use a personal account at an electric vehicle charging station to perform charging operations, and the electric vehicle charging fee for the corresponding charging operation is paid by the user himself. Enterprises can provide specific users such as enterprise employees with an enterprise account, and specific users can use the enterprise account for charging operations at the charging station, and the electric vehicle charging fee for the corresponding charging operation is paid by the enterprise or the user. However, existing user management only manages individuals or fields at a single level, since users may have multiple identities and there are multiple business models between charging station operators and individuals or enterprises, such as users may belong to specific companies, a contractual relationship may between a specific electric vehicle charging station operator and specific companies, and a contractual relationship may between different electric vehicle charging station operators, so that users may roam between the electric vehicle charging stations of different electric vehicle charging station operators. There may be different charging mechanisms and corresponding discounts between different electric vehicle charging station operators. The integration of the various scenarios is complex and the inability to effectively integrate charging scenarios and rate calculations across different applications will result in difficulties for management both on users and charging operations. Therefore, how to reduce the difficulty of installation and management of electric vehicle charging stations and simultaneously meet the charging needs of different user categories and the cost management needs of charging point operators will be an urgent issue for the industry to solve.

### BRIEF SUMMARY OF THE INVENTION

In an embodiment of a method for multi-dimension electric vehicle charging management for use in a server that connects to multiple electric vehicle charging stations via a network is provided. First, configuration setting data corresponding to each electric vehicle charging station is provided, wherein the configuration setting data at least records at least one candidate business hours of each electric vehicle charging station, at least one user category provided for using the electric vehicle charging station during the candidate business hours, and whether the user category can make a reservation to use each electric vehicle charging station during the candidate business hours. A service application instruction corresponding to a specific electric vehicle charging station among the electric vehicle charging stations is received from the specific electric vehicle charging station or a mobile device through a network, wherein the service application instruction includes at least one specific user identity data corresponding to a specific user. In response to the service application instruction, a corresponding specific user category is determined based on the specific user identity data. Then, the configuration setting data of the specific electric vehicle charging station is obtained, and it is determined whether the specific user can use or make a reservation to use the specific electric vehicle charging station at a receiving time for receiving the service application instruction according to the receiving time, the specific user category, and the configuration setting data of the specific electric vehicle charging station.

An embodiment of a method for multi-dimension electric vehicle charging management at least comprises a mobile device corresponding to a specific user, a plurality of electric vehicle charging stations, and a server. Each electric vehicle charging station has a network connection capability to connect with the server. The server is connected with each electric vehicle charging station through a network and records configuration setting data corresponding to each electric vehicle charging station, wherein the configuration setting data at least records at least one candidate business hours of each electric vehicle charging station, at least one user category provided for using the electric vehicle charging station during the candidate business hours, and whether users of the user category can make a reservation to use each electric vehicle charging station during the candidate business hours. The server receives a service application instruction corresponding to a specific electric vehicle charging station among the electric vehicle charging stations from the specific electric vehicle charging station or a mobile device through a network, wherein the service application instruction includes at least one specific user identity data corresponding to a specific user. The server determines a corresponding specific user category based on the specific user identity data in response to the service application instruction, obtains the configuration setting data of the specific electric vehicle charging station, and determines whether the specific user can use or make a reservation to use the specific electric vehicle charging station at a receiving time for receiving the service application instruction according to the receiving time, the specific user category, and the configuration setting data of the specific electric vehicle charging station.

In some embodiments, rate setting data corresponding to at least one charging point operator is provided, wherein the rate setting data records at least a basic charging rate and a discount rate corresponding to at least one user category. In response to the service application instruction, the server determines a corresponding first charging point operator according to the specific electric vehicle charging station. The server obtains the rate setting data of the first charging point operator, and determines a charging fee for a specific user to perform a charging operation at the specific electric vehicle charging station according to the specific user category and the rate setting data of the first charging point operator.

In some embodiments, the service application instruction is a charging request, and the server transmits a charging authorization instruction to the specific electric vehicle charging station through the network in response to the charging request, so that the specific electric vehicle charging station performs the charging operation. During the execution of the charging operation, the server continuously receives charging information from the specific electric vehicle charging station via the network.

In some embodiments, a charging fee for the charging operation is calculated according to the charging information and the charging rate. It is determined whether the specific user category is a second charging point operator. When the specific user category is the second charging point operator, the charging fee corresponding to the specific user is accumulated, and a bill corresponding to the accumulated charging fee is periodically provided to the specific user through the second charging point operator.

In some embodiments, a charging fee is calculated for the charging operation according to the charging information and the charging rate. The charging fee corresponding to the specific user is accumulated and a bill corresponding to the accumulated charging fee is periodically provided to the specific user.

In some embodiments, the service application instruction is a charging availability query, and in response to the charging availability query, the server determines whether the receiving time falls within the at least one candidate business hours of the specific electric vehicle charging station and whether the specific user category corresponding to the specific user belongs to the at least one user category. When the receiving time falls within the at least one candidate business hours of the specific electric vehicle charging station, and the specific user category corresponding to the specific user belongs to the at least one user category, the server transmits a charging available result to the mobile device via the network. The charging available result indicates that the specific user can perform a charging operation at the specific electric vehicle charging station at the receiving time.

In some embodiments, the service application instruction is a charging reservation request, the charging reservation request specifying a reservation time, and in response to the charging reservation request, the server determines whether the reservation time falls within the at least one candidate business hours of the specific electric vehicle charging station and whether the specific user category corresponding to the specific user belongs to the at least one user category. When the reservation time falls within the at least one candidate business hours of the specific electric vehicle charging station, and the specific user category corresponding to the specific user belongs to the at least one user category, the specific electric vehicle charging station is reserved for the specific user at the reservation time, wherein the specific electric vehicle charging station cannot receive charging requests from other users at the reservation time.

In some embodiments, the service application instruction is a charging rate query, and in response to the charging rate query, the server determines whether the receiving time falls within the at least one candidate business hours of the specific electric vehicle charging station and whether the specific user category corresponding to the specific user belongs to the at least one user category. When the receiving time falls within the at least one candidate business hours of the specific electric vehicle charging station and the specific user category corresponding to the specific user belongs to the at least one user category, the server transmits the charging rate for the specific user to perform the charging operation at the specific electric vehicle charging station to the mobile device via the network.

In some embodiments, the server receives a query of available charging stations from a target mobile device via the network, wherein the query of available charging stations includes at least one target user identity data corresponding to a target user. In response to the query of available charging stations, the server determines a corresponding target user category according to the target user identity data, obtains the configuration setting data of each electric vehicle charging station, and determines at least one of the electric vehicle charging stations that the target user can use or reserve to use at a receiving time for receiving the query of available charging stations according to the receiving time, the target user category, and the configuration setting data of each corresponding electric vehicle charging station, in order to generate an available charging station result. The server sends the available charging station result back to the target mobile device via the network.

Methods for multi-dimension electric vehicle charging management may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for multi-dimension electric vehicle charging management of the invention;

FIG. 2 is a schematic diagram illustrating an embodiment of an electric vehicle charging station of the invention;

FIG. 3 is a schematic diagram illustrating an embodiment of a server of the invention;

FIG. 4 is a flowchart of an embodiment of a method for multi-dimension electric vehicle charging management of the invention;

FIG. 5 is a flowchart of another embodiment of a method for multi-dimension electric vehicle charging management of the invention;

FIG. 6 is a flowchart of another embodiment of a method for multi-dimension electric vehicle charging management of the invention;

FIG. 7 is a flowchart of another embodiment of a method for multi-dimension electric vehicle charging management of the invention;

FIG. 8 is a flowchart of another embodiment of a method for multi-dimension electric vehicle charging management of the invention;

FIG. 9 is a flowchart of another embodiment of a method for determining whether a specific user can use a specific electric vehicle charging station of the invention;

FIG. 10 is a flowchart of an embodiment of a method for determining whether a specific user can make a reservation on a specific electric vehicle charging station of the invention;

FIG. 11 is a flowchart of another embodiment of a method for multi-dimension electric vehicle charging management of the invention; and

FIG. 12 is a flowchart of another embodiment of a method for multi-dimension electric vehicle charging management of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

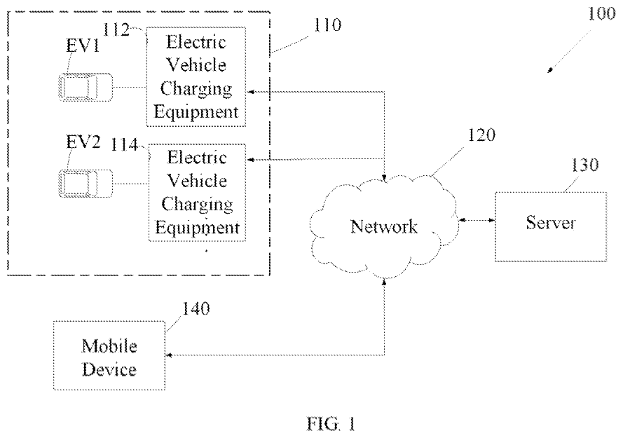

FIG. 1 is a schematic diagram illustrating an embodiment of a system for multi-dimension electric vehicle charging management of the invention. The system for multi-dimension electric vehicle charging management 100 is applicable to a plurality of electric vehicle charging stations. It is understood that, in some embodiments, the electric vehicle charging stations may be located within a charging field 110. For example, the charging field 110 may be a MDU (Multiple Dwelling Unit), a community, a building, a parking lot, or a shopping mall. Note that, in some embodiments, the charging field 110 may have a power limit. As shown in FIG. 1, the system for multi-dimension electric vehicle charging management 100 of the present invention includes a plurality of electric vehicle charging stations, such as 112 and 114, and a server 130 connected to the electric vehicle charging stations 112, 114 via a network 120. The electric vehicle charging station 112 can provide the electric vehicle EV1 to perform a charging operation. Similarly, the electric vehicle charging station 114 can provide the electric vehicle EV2 to perform a charging operation. In some embodiments, the network 120 may be a wired network, a telecommunication network, a wireless network, such as a Wi-Fi network, or the like. The server 130 can receive various data from the electric vehicle charging station via the network 120, and transmit relevant signals to the electric vehicle charging station. The electric vehicle charging stations can perform related operations according to the signals received from the server 130. For example, when the electric vehicle EV1 is coupled to the electric vehicle charging station 112 through a charging gun of the electric vehicle charging station 112 to perform a charging operation, the electric vehicle charging station 112 can charge the electric vehicle EV1 for the charging operation. The charging information is transmitted via the network 120, and the server 130 can receive the charging information of the corresponding charging operation from the electric vehicle charging equipment 112 via the network 120. In some embodiments, the charging information may include at least a charging start time, a charging period, an output power, and/or related information indicating whether a load adjustment operation is being performed. The server 130 can know the usage status of the corresponding electric vehicle charging station according to the charging information.

It is noted that the user can connect the electric vehicle EV1 and the charging station 112 to each other, such as inserting a charging gun into the charging port of the electric vehicle to send a charging request corresponding to the charging station 112 to use the charging station 112. The charging station 112 performs a charging operation for the electric vehicle EV1. Similarly, the user can connect the electric vehicle EV2 and the charging station 114 to each other, such as inserting a charging gun into the charging port of the electric vehicle to send a charging request corresponding to the charging station 114 to use the charging station 114. It is understood that, in some embodiments, the server 130 may directly or indirectly receive a charging request from a mobile device (not shown in FIG. 1) of the owner of the electric vehicle EV1, and generate a charging authorization command based on the charging request and transmit it to the charging station 112 via the network 120, so that the charging station 112 outputs power to the electric vehicle EV1, such as an electric scooter or an electric car, which is electrically connected to it, or prohibits the charging station 112 from outputting power to the electric vehicle EV1. It is reminded that, in some embodiments, the charging request may be accompanied by an identity authentication and/or a payment mechanism, and the charging authorization command will only be generated after the identity authentication and/or payment mechanism is completed. In some embodiments, the user of the electric vehicle EV1 can use his/her mobile device to download and install an application to generate a charging request through the user interface of the application. In some embodiments, the user can scan a Quick Response Code (QR code) on the charging station 112 through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle EV1 can use an RFID card to approach an induction area (not shown in FIG. 1) on the charging equipment 112 to generate a corresponding charging request, and sent it to the server 130 via the network 120. It is reminded that, in some embodiments, each user can have an RFID card.

It is noted that, the mobile device 140 may be corresponded to the owner of the electric vehicle, which can be any electronic device capable of Internet access, such as mobile devices, such as mobile phones, smart phones, personal digital assistants, global positioning systems, and notebook computers. In some embodiments, the mobile device 140 can receive status information and notifications of the corresponding charging operation from the cloud management server 130 via the network 120. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on.

As mentioned, the charging field 110 may have a power limit. It is understood that, the server 130 can perform a load adjustment operation for the electric vehicle charging stations according to at least one energy management scheme. Specifically, the server 130 can generate an instruction and send the instruction to the respective charging station (112, 114) via the network 120 to control the charging station to output power for charging with a specified power parameter, such as a specified amperage, during a specific period of time to the electric vehicle connected to the station, or to prohibit the charging station from outputting power to the electric vehicle.

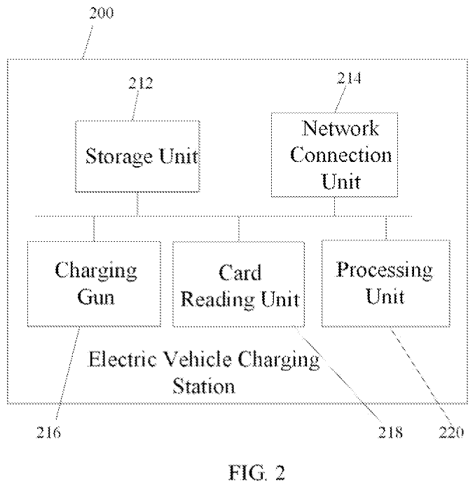

FIG. 2 is a schematic diagram illustrating an embodiment of an electric vehicle charging station of the invention. The electric vehicle charging station 200 shown in FIG. 2 can be applied to the first charging station 112 or the second charging station 114 in FIG. 1, which has processing and computing capabilities to perform charging management operations for the electric vehicle charging station. The electric vehicle charging station 200 has a network connection capability to receive, download or update various parameters and information required for charging management calculations.

The electric vehicle charging station 200 at least comprises a storage unit 212, a network connection unit 214, a charging gun 216, a card reading unit 218, and a processing unit 220. The storage unit 212 may be a memory or a database for storing and recording related data. The data may be related information such as charging station identification code (ID) of the electric vehicle charging station and charging requests. It should be noted that the aforementioned information is only example, and the invention is not limited thereto. The network connection unit 214 can use a network, such as a wired network, a telecommunications network, and a wireless network, such as a Wi-Fi network, to receive, download, or update various parameters and information required for charging management operations. The charging gun 216 may include one or more charging connectors that meet the same charging interface specification or meet different charging interface specifications, and are electrically connected to the corresponding electric vehicle. The card reading unit 218 may be an RFID reading unit for sensing information of a physical card, such as RFID card. The information sensed from the RFID card may be a card identification code and/or a user identification code of the physical card. The processing unit 220 can control the operations of related software and hardware in the electric vehicle charging station 200, and cooperate with the server 130 to execute the methods of the invention. Related details will be described later. It is noted that, in some embodiments, the processing unit 220 may be a general-purpose controller, a Micro-Control Unit, MCU, or a Digital Signal Processor, DSP, etc., to provide functions of data analysis, processing and calculation, but the present invention is not limited to this. In one embodiment, the processing unit 220 may use the network connection unit 214 to transmit the power state of the corresponding electric vehicle through a network for a cloud management server, such as the cloud server 130, for subsequent charging management. In another embodiment, the processing unit 220 can obtain the power parameter of a charging operation from the server 130, determine the output power according to the power parameter received from the server 130, and output the power to at least one electric vehicle through the charging gun 216 to perform the charging operation.

It is understood that, the electric vehicle charging station 200 has an upper power limit value and a lower power limit value. Specifically, the electric vehicle charging station 200 can use the upper power limit value as the power parameter at the highest to output power to the electric vehicle during a charging operation. On the other hand, the electric vehicle charging station 200 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

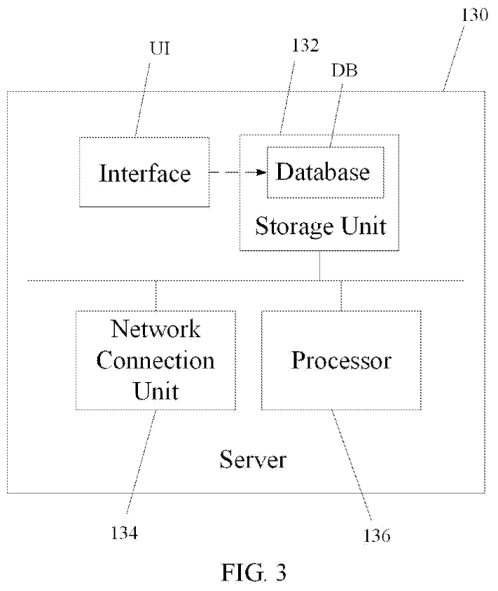

FIG. 3 is a schematic diagram illustrating an embodiment of a server of the invention. As shown in FIG. 3, the server 130 of the invention can be any processor-based electronic device, which comprises at least a storage unit 132, a network connection unit 134, and a processor 136. It is noted that, the server 130 can receive various data corresponding to a plurality of electric vehicle charging equipment in a charging field. The server 130 can directly or indirectly receive a charging request from a mobile device or a charging station, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 132, such as a memory, can store and record relevant data, such as various data of the corresponding electric vehicle charging stations. The storage unit 132 may include a database DB for recording configuration setting data corresponding to the electric vehicle charging station 112 or 114. The configuration setting data may record at least one candidate business hours of the electric vehicle charging station 112 or 114, at least one user category provided for use during the candidate business hours, and whether the user category can make a reservation to use each electric vehicle charging station during the candidate business hours and so on. The database DB can further record the user identity data of each user and the corresponding user category, wherein each user corresponds to at least one user category. In other words, a specific user category can be obtained through the database DB according to a specific user identity data of a specific user.

It should be noted that, in some embodiments, a specific table can record configuration setting data corresponding to a specific electric vehicle charging station, wherein the configuration setting data at least records at least one candidate business hours of the specific electric vehicle charging station, at least one user category provided for use during the candidate business hours, and whether the user category can make a reservation to use each electric vehicle charging station during the candidate business hours and so on. Table 1 shows an example of a corresponding table.

TABLE 1

| | | | | Whether user |
|---|---|---|---|---|
| Electric vehicle | | | User | category |
| charging station | Charging | Candidate | category | can make |
| identification | point | business | provided | reservation |
| code | operator | hours | for use | to use |
| CH001 | CPO1 | 5pm-8am | U1, U2, | Yes |
| | | | CPO1, CPO2 | |
| CH002 | CPO2 | 24 hours | U1, CPO1 | No |
| CH003 | CPO2 | 6pm-6am | CPO1, CPO2, | Yes |
| | | | U2 | |
| . . . | | . . . | . . . | . . . |

As shown in Table 1, after the specific user identity data is obtained, a specific user category can be determined according to the specific user identity data, and the Table 1 can be looked up to obtain whether the specific user can use or make a reservation to use the specific electric vehicle charging station at a receiving time for receiving the service application instruction according to the receiving time, the specific user category, and the configuration setting data of the specific electric vehicle charging station. In this example, the user categories include U1, U2, CPO1, and CPO2, wherein the user category U1 represents a member of the corresponding electric vehicle charging station, the user category U2 represents a general user, the user category CPO1 represents a member of the first charging point operator, and the user category CPO2 represents a member of the second charging point operator. In this example, it can be known that the charging point operator of the electric vehicle charging station CH001 is CPO1, the candidate business hours are 5 pm-8 am, and users whose user categories are U1, U2, CPO1 or CPO2 can use or make reservations to use this electric vehicle charging station during the candidate business hours. In other words, all users will not be able to use or reserve the electric vehicle charging station CH001 for use during non-candidate business hours (i.e., 8 am-5 pm). Similarly, it can be known from Table 1 that the charging point operator of electric vehicle charging station CH002 is CPO2, the candidate business hours are 24 hours, and users whose user category is U1 or CPO1 can use this electric vehicle charging station during the candidate business hours, However, no user category can make a reservation to use this electric vehicle charging station. In other words, users with the user category U1 or CPO1 can use the electric vehicle charging station CH002 at any time of the day, and users with the user category U2 or CPO2 cannot use the electric vehicle charging station CH002 at any time of the day and the electric vehicle charging station CH002 is not allowed to be reserved for use. Similarly, it can be known from Table 1 that the charging point operator of electric vehicle charging station CH003 is CPO2, the candidate business hours are 6 pm-6 am, and users whose user categories are CPO1, CPO2 or U2 can use or make reservations to use this electric vehicle charging station during the candidate business hours. In other words, users whose user category is CPO1, CPO2 or U2 can only use or reserve electric vehicle charging station CH003 during the period of 6 pm-6 am, while users whose user category is U1 cannot use electric vehicle charging station CH003. It is noted that, the above table is an example of the application, and the present invention is not limited thereto. With the configuration setting data, when a service application instruction is received, it can be known that whether a specific user can use or reserve to use a specific electric vehicle charging station at the receiving time for receiving the service application instruction based on the receiving time, the specific user category of the specific user corresponding to the service application instruction, and the configuration setting data of the specific electric vehicle charging station. In some embodiments, the configuration setting data corresponding to the specific electric vehicle charging station may further record information about whether the specific electric vehicle charging station is open for use, the user categories that are open for use, and the candidate open time periods, and the like. In other words, It can be known from the configuration setting data corresponding to the specific electric vehicle charging station that whether the specific electric vehicle charging station can be opened for use, which user categories can be used after it has been opened, and candidate opening time periods.

It should be noted that, in some embodiments, another specific table can record the rate setting data corresponding to the charging point operators CP01 and CPO2. Table 2 shows an example of a corresponding table.

TABLE 2

| Charging | | | | | | |
|---|---|---|---|---|---|---|
| point | | | | | | |
| operator | Basic | | | | | |
| identification | charging | Discount Rate | | | | |
| code | rate | CPO1 | CPO2 | U1 | U2 | Payment Mode |
| C1 | $0.6 | 50% | 25% | 15% | 10% | Billing users by C1 at |
| | | | | | | the end of each month |
| C2 | $0.8 | 30% | 50% | 25% | 0% | Billing directly to |
| | | | | | | users at the end of each |
| | | | | | | month |
| . . . | . . . | . . . | . . . | . . . | . . . | . . . |

As shown in Table 2, the Table 2 can be looked up to determines a charging fee for a specific user to perform a charging operation at the specific electric vehicle charging station according to the specific user category and the rate setting data of the respective charging point operator. In this example, the charging point operator can be C1 or C2 and the user categories include U1, U2, CPO1 and CPO2, wherein the user category U1 represents the members of the corresponding electric vehicle charging station, the user category U2 represents general users, and the user category CPO1 represents the members of the first charging point operator C1, and the user category CPO2 represents the members of the second charging point operator C2. In this example, when the charging point operator of the specific electric vehicle charging station is the first charging point operator C1, the basic charging rate is 0.6 dollars per minute, and the discount rate for users of the user category CPO1 is 50%, that is, the charging rate for users of the user category CPO1 for charging at the specific electric vehicle charging station is reduced to 0.3 dollars per minute. Similarly, when the charging point operator of the specific electric vehicle charging station is the first charging point operator C1, the basic charging rate is 0.6 dollars per minute, and the discount rate for users of the user category CPO2 is 20%, that is, the charging rate for users of user category CPO2 roaming to the specific electric vehicle charging station for charging operations is 0.45 dollars per minute; the discount rate for users of user category U1 is 15%, so the charging rate for users of user category U1 to charge at the specific electric vehicle charging station is 0.51 dollars per minute; the discount rate for users in user category U2 is 15%, so the charging rate for users of user category U2 to charge at the specific electric vehicle charging station is 0.54 dollars per minute. When the charging point operator of the specific electric vehicle charging station is the second charging point operator C2, its basic charging rate is 0.8 dollars per minute, and the discount rate for users of the user category CPO1 is 30%. Therefore, the charging rate for users of user category CPO1 roaming to the specific electric vehicle charging station is 0.56 dollars per minute. Similarly, when the charging point operator of the specific electric vehicle charging station is the second charging point operator C2, the basic charging rate is 0.8 dollars per minute, and the discount rate for users of the user category CPO2 is 50%, so the charging rate for users of user category CPO2 for charging at the specific electric vehicle charging station is 0.4 dollars per minute; the discount rate for users of user category U1 is 25%, so the charging rate for users of user category U1 for charging at the specific electric vehicle charging station is 0.6 dollars per minute; and the discount rate for users of user category U2 is 0, which means that users of user category U2 have no discount at the specific electric vehicle charging station, so the charging rate for users of user category U2 for charging at the specific electric vehicle charging station is 0.8 dollars per minute. For example, when a first user belonging to the user category CPO1 performs a charging operation at a specific electric vehicle charging station operated by the first charging point operator C1, a corresponding rate setting data can be obtained by a table lookup operation performed on the Table 2 based on the user category CPO1 and the corresponding charging point operator C1 to determine that the charging rate for the first user to charge at the specific electric vehicle charging station is 0.3 dollars per minute. When the first user roams to an electric vehicle charging station of the second charging point operator C2 for charging operation, a corresponding rate setting data can be obtained by a table lookup operation performed on the Table 2 according to the user category CPO1 corresponding to the first user and the charging point operator C2 corresponding to the electric vehicle charging station, and it can be known that the corresponding discount rate for the first user is 30%, so the charging rate for the first user to charge at this electric vehicle charging station is 0.56 dollars per minute. It is noted that, the above table data and fields are only examples of the application, and the present invention is not limited thereto. With the rate setting data corresponding to the charging point operators CPO1 and CPO2, it can be used to determine the charging rate for the specific user to perform charging operations at the specific electric vehicle charging station according to the specific user category and the rate setting data of the corresponding charging point operator. On the other hand, the rate setting data of the corresponding specific charging point operator can further record the payment mode of the charging fee corresponding to the specific charging point operator. For example, the payment mode of the charging point operator C1 is to request payment from the user through the charging point operator C1 at the end of each month, and the payment mode of the charging point operator C2 is that the server directly asks the user for payment at the end of each month. It is noted that, the above payment modes are only examples of the application, and the present invention is not limited thereto.

It is noted that, in some embodiments, each electric vehicle charging station may be bound to one or more user categories. In other words, only the bound user category can exclusively use the electric vehicle charging equipment. In some embodiments, the database DB can further record the payment information corresponding to the account and/or user categories bound to each electric vehicle charging station, the details of which will be described later. It is reminded that, in some embodiments, the server 130 may provide an interface UI for the manager of the respective electric vehicle charging station to set the aforementioned configuration setting data and rate setting data of the corresponding electric vehicle charging station data, so as to facilitate the server 130 to perform the methods for multi-dimension electric vehicle charging management of the present invention. In some embodiments, the server 130 may further provide the interface UI for the user bound to the respective electric vehicle charging station to set the aforementioned data, such as the payment information and so on. Through the network connection unit 134, the server 130 can be coupled and communicated with the respective electric vehicle charging station via the network 120, such as a wired network, a telecommunication network, and a wireless network, such as a Wi-Fi network. The relevant data/signals/commands are transmitted to the electric vehicle charging station via the network 120 to control whether the electric vehicle charging station outputs electric power and specify the electric parameters to output electric power to charge the electric vehicle. The processor 136 can control the operations of the relevant software and hardware in the server 130, and execute the methods for multi-dimension electric vehicle charging management of the present invention, the details of which will be described later. It should be noted that, in some embodiments, the processor 136 may be a general-purpose controller, a microcontroller, or a digital signal controller, etc., for providing data analysis, processing, and computing functions, but the present invention is not limited thereto.

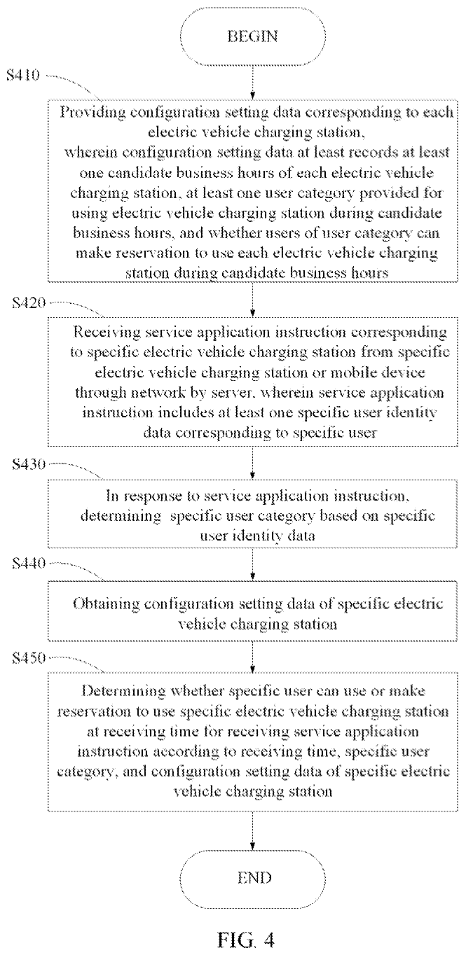

FIG. 4 is a flowchart of an embodiment of a method for multi-dimension electric vehicle charging management of the invention. The method for multi-dimension electric vehicle charging management of the invention is applicable to a server connected to a plurality of electric vehicle charging stations via a network. First, in step S410, the server provides configuration setting data corresponding to each electric vehicle charging station. The configuration setting data may at least record at least one candidate business hours of each electric vehicle charging station, at least one user category provided for using the electric vehicle charging station during the candidate business hours, and whether users of the user category can make a reservation to use each electric vehicle charging station during the candidate business hours as shown in Table 1. In step S420, the server receives a service application instruction corresponding to a specific electric vehicle charging station among the electric vehicle charging stations from the specific electric vehicle charging station or a mobile device through the network, wherein the service application instruction includes at least one specific user identity data corresponding to a specific user. It is noted that, in some embodiments, the mobile device may use the application to scan the quick response code corresponding to the electric vehicle charging station, so as to transmit the service application instruction corresponding to the electric vehicle charging station to the server via the network. It should be reminded that the server can record the user identity data of each user and its corresponding user category. Next, in step S430, in response to the service application instruction, the server determines a corresponding specific user category based on the specific user identity data. Then, in step S440, the server obtains the configuration setting data of the specific electric vehicle charging station, and in step S450, determines whether the specific user can use or make a reservation to use the specific electric vehicle charging station at a receiving time for receiving the service application instruction according to the receiving time, the specific user category, and the configuration setting data of the specific electric vehicle charging station. It is reminded that the method of how to determine whether a specific user can use or make a reservation to use a specific electric vehicle charging station at the receiving time based on the aforementioned data will be described later. For example, in some embodiments, the server may determine whether a specific user can use or make a reservation to use the specific electric vehicle charging station at the receiving time by determining whether the receiving time of receiving the service application instruction falls within the candidate business hours of the specific electric vehicle charging station, the specific user category of the specific user, and the service application categories can be used on the specific electric vehicle charging station for the specific user category. When the receiving time falls within the candidate business hours of the specific electric vehicle charging station and the specific user category of the specific user can use and reserve the designated service application category at the specific electric vehicle charging station, it is determined that the specific user can use and reserve to use the specific electric vehicle charging station at the receiving time. It should be reminded that the aforementioned method of determining whether a specific user can use or reserve to use a specific electric vehicle charging station at the receiving time is only an example of the application, and the present invention is not limited thereto.

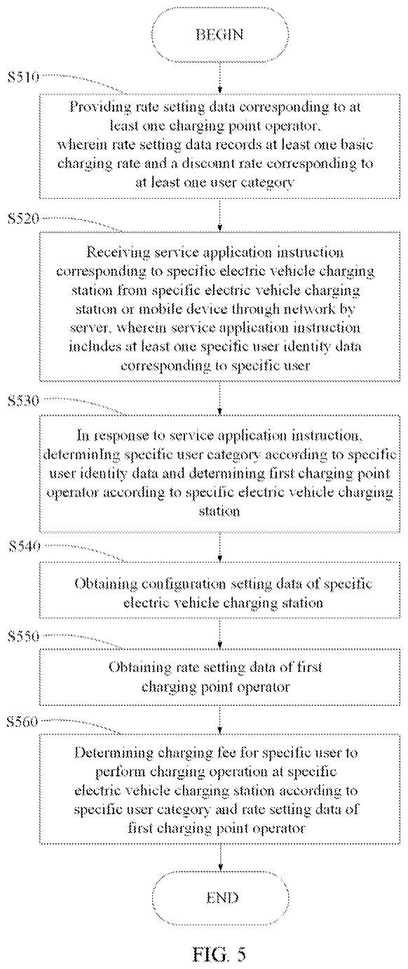

FIG. 5 is a flowchart of another embodiment of a method for multi-dimension electric vehicle charging management of the invention. The method for multi-dimension electric vehicle charging management of the invention is applicable to an electric vehicle charging station such as the specific electric vehicle charging station specified in the embodiment of FIG. 4 and a server. In this embodiment, the server may determine the charging rate for a specific user at the specific electric vehicle charging station according to the user category of the user and the rate setting data of the charging point operator.

First, in step S510, the server provides rate setting data corresponding to at least one charging point operator, wherein the rate setting data records at least one basic charging rate and a discount rate corresponding to at least one user category. It is noted that different user categories may have different basic charging rates and discount rates at the electric vehicle charging stations of different charging point operators, as shown in Table 2. In step S520, the server receives a service application instruction corresponding to the specific electric vehicle charging station from the specific electric vehicle charging station or a mobile device through the network. Note that the service application instruction may include at least one specific user identity data corresponding to a specific user. It should be noted that, in some embodiments, the mobile device can scan the quick response code of the corresponding electric vehicle charging station by using the application, so as to send the service application instruction of the corresponding electric vehicle charging station to the server through the network. It is reminded that, the server can record the user identity data of each user and its corresponding user category, as well as the corresponding relationship between each electric vehicle charging station and the respective charging point operator, and the corresponding rate setting data of each charging point operator. Next, in step S530, in response to the service application instruction, the server determines a specific user category according to the specific user identity data and determines a first charging point operator according to the specific electric vehicle charging station. Then, in step S540, the server obtains the configuration setting data of the specific electric vehicle charging station, and in step S550, obtains the rate setting data of the first charging point operator. After obtaining the rate setting data of the first charging point operator, in step S560, the server determines a charging fee for the specific user to perform a charging operation at the specific electric vehicle charging station according to the specific user category and the rate setting data of the first charging point operator.

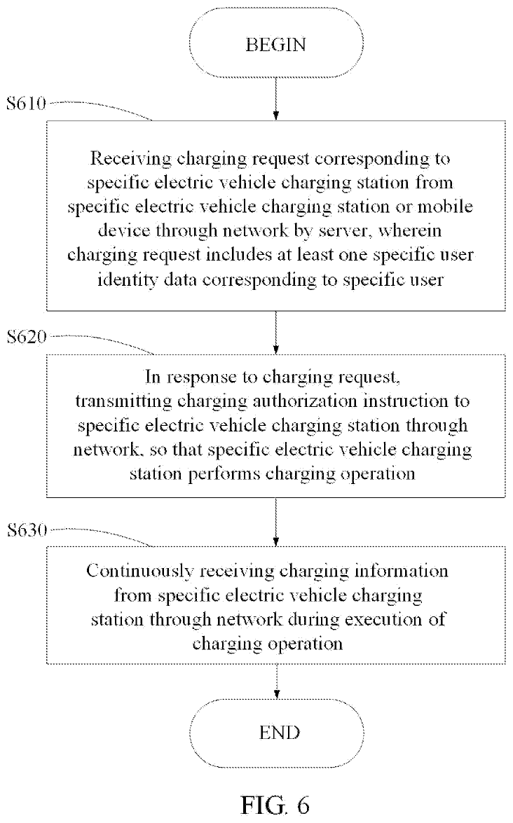

FIG. 6 is a flowchart of another embodiment of a method for multi-dimension electric vehicle charging management of the invention. The method for multi-dimension electric vehicle charging management of the invention is applicable to an electric vehicle charging station such as the specific electric vehicle charging station specified in the embodiment of FIG. 4 and a server. In this embodiment, the service application instruction can be a charging request and the server may instruct a specific electric vehicle charging station to perform a charging operation and obtain the relevant status of the charging operation of the specific electric vehicle charging station. First, in step S610, the server receives a charging request corresponding to the specific electric vehicle charging station from the specific electric vehicle charging station or a mobile device through a network. The charging request includes at least one specific user identity data corresponding to a specific user. It should be noted that, in some embodiments, the mobile device can scan the quick response code of the corresponding electric vehicle charging station by using the application program, so as to send the charging request of the corresponding electric vehicle charging station to the server through the network. It is reminded that the server can record the user identity data of each user and its corresponding user category, as well as the corresponding relationship between each electric vehicle charging station and the respective charging point operator, and the corresponding rate setting data of each charging point operator. Next, in step S620, in response to the charging request, the server transmits a charging authorization instruction to the specific electric vehicle charging station through the network, so that the specific electric vehicle charging station performs the charging operation. It should be noted that, in this embodiment, the server obtains the configuration setting data of the specific electric vehicle charging station, and determines that the specific user can use the specific electric vehicle charging station at the receiving time when the charging request is received according to the receiving time of receiving the charging request, the specific user category, and the configuration setting data of the specific electric vehicle charging station. Next, in step S630, the server continuously receives a charging information from the specific electric vehicle charging station through the network during the execution of the charging operation. It is reminded that the charging information may at least include a charging time or a charging amount, but it is not limited thereto. During the charging operation, the server can know the charging amount or charging time of an electric vehicle that has been charged in the corresponding charging operation through the charging information.

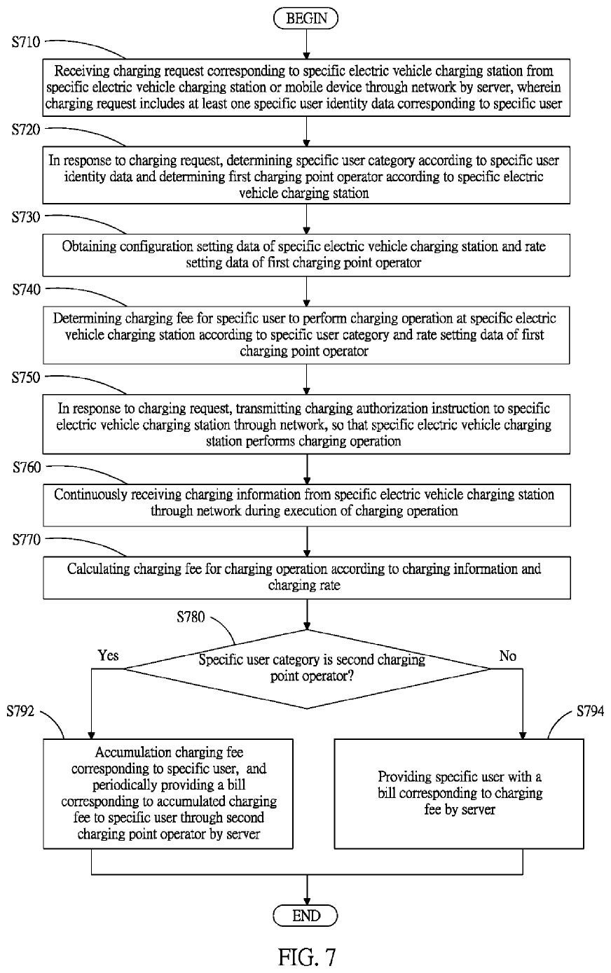

FIG. 7 is a flowchart of another embodiment of a method for multi-dimension electric vehicle charging management of the invention. The method for multi-dimension electric vehicle charging management of the invention is applicable to an electric vehicle charging station such as the specific electric vehicle charging station specified in the embodiment of FIG. 4 and a server. In this embodiment, when the service application instruction is a charging request and the specific user is a member of a specific charging point operator, the specific charging point operator can periodically provide the specific user with a bill corresponding to accumulated charging fee for performing a periodic payment operation.

First, in step S710, the server receives a charging request corresponding to the specific electric vehicle charging station from the specific electric vehicle charging station or a mobile device through a network. The charging request includes at least one specific user identity data corresponding to a specific user. It should be noted that, in some embodiments, the mobile device can scan the quick response code of the corresponding electric vehicle charging station by using the application program, so as to send the charging request of the corresponding electric vehicle charging station to the server through the network. It is reminded that the server can record the user identity data of each user and its corresponding user category, as well as the corresponding relationship between each electric vehicle charging station and the respective charging point operator, and the corresponding rate setting data of each charging point operator. It is noted that, the rate setting data records at least one basic charging rate and a discount rate corresponding to at least one user category. It is noted that different user categories may have different basic charging rates and discount rates at the electric vehicle charging stations of different charging point operators, as shown in Table 2. Next, in step S720, in response to the charging request, the server determines a specific user category according to the specific user identity data and determines a first charging point operator according to the specific electric vehicle charging station. Then, in step S730, the server obtains the configuration setting data of the specific electric vehicle charging station and the rate setting data of the first charging point operator. After obtaining the configuration setting data of the specific electric vehicle charging station and the rate setting data of the first charging point operator, in step S740, the server determines a charging fee for the specific user to perform a charging operation at the specific electric vehicle charging station according to the specific user category of the specific user and the rate setting data of the first charging point operator. In step S750, in response to the charging request, the server transmits a charging authorization instruction to the specific electric vehicle charging station through the network, so that the specific electric vehicle charging station performs the charging operation. It should be noted that, in this embodiment, the server obtains the configuration setting data of the specific electric vehicle charging station, and determines that the specific user can use the specific electric vehicle charging station at the receiving time when the charging request is received according to the receiving time of receiving the charging request, the specific user category, and the configuration setting data of the specific electric vehicle charging station. Next, in step S760, the server continuously receives charging information from the specific electric vehicle charging station through the network during the execution of the charging operation. It is reminded that the charging information may at least include a charging time or a charging amount, but it is not limited thereto. During the charging operation, the server can know the charging amount or charging time of an electric vehicle that has been charged in the corresponding charging operation through the charging information.

In step S770, the server calculates a charging fee for the charging operation according to the charging information and the charging rate. Next, in step S780, the server determines whether the specific user category is a second charging point operator. When the specific user category is the second charging point operator (Yes in step S780), in step S792, the server accumulates the charging fee corresponding to the specific user, and periodically provides a bill corresponding to the accumulated charging fee to the specific user through the second charging point operator to perform the periodic payment operation. When the specific user category is not the second charging point operator (No in step S780), in step S794, the server provides the specific user with a bill corresponding to the charging fee to perform the periodic payment operation. In other words, in this embodiment, the charging fee related to the users of the second charging point operator will be collected and requested for payment periodically by the second charging point operator. It is reminded that, the aforementioned periodic payment operation can be performed in a fixed period, such as weekly, monthly, quarterly, or yearly. The present invention is not limited to any period.

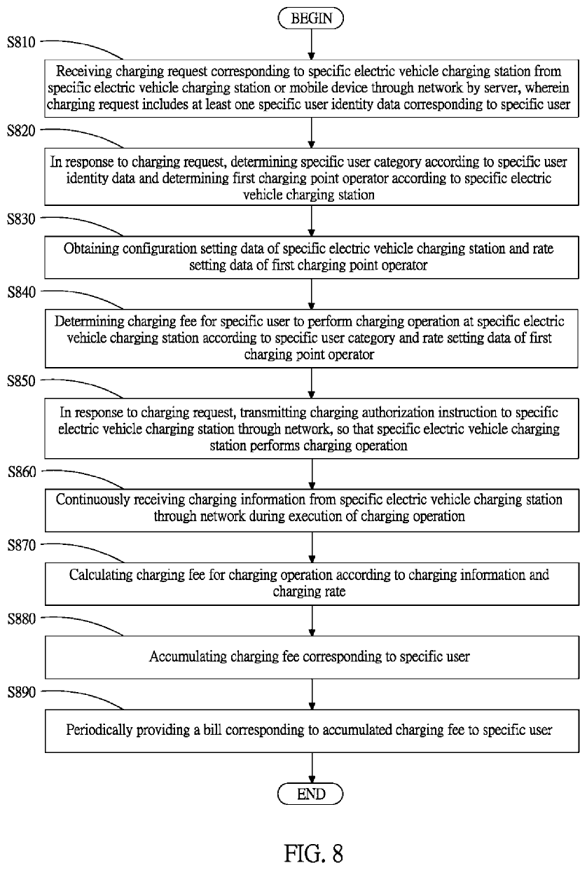

FIG. 8 is a flowchart of another embodiment of a method for multi-dimension electric vehicle charging management of the invention. The method for multi-dimension electric vehicle charging management of the invention is applicable to an electric vehicle charging station such as the specific electric vehicle charging station specified in the embodiment of FIG. 4 and a server. In this embodiment, when the service application instruction is a charging request, the server will periodically request payment on the charging fee for a specific user.

First, in step S810, the server receives a charging request corresponding to the specific electric vehicle charging station from the specific electric vehicle charging station or a mobile device through a network. The charging request includes at least one specific user identity data corresponding to a specific user. It should be noted that, in some embodiments, the mobile device can scan the quick response code of the corresponding electric vehicle charging station by using the application program, so as to send the charging request of the corresponding electric vehicle charging station to the server through the network. It is reminded that the server can record the user identity data of each user and its corresponding user category, as well as the corresponding relationship between each electric vehicle charging station and the respective charging point operator, and the corresponding rate setting data of each charging point operator. It is noted that, the rate setting data records at least one basic charging rate and a discount rate corresponding to at least one user category. It is noted that different user categories may have different basic charging rates and discount rates at the electric vehicle charging stations of different charging point operators, as shown in Table 2. Next, in step S820, in response to the charging request, the server determines a specific user category according to the specific user identity data and determines a first charging point operator according to the specific electric vehicle charging station. Then, in step S830, the server obtains the configuration setting data of the specific electric vehicle charging station and the rate setting data of the first charging point operator. After obtaining the configuration setting data of the specific electric vehicle charging station and the rate setting data of the first charging point operator, in step S840, the server determines a charging fee for the specific user to perform a charging operation at the specific electric vehicle charging station according to the specific user category of the specific user and the rate setting data of the first charging point operator. In step S850, in response to the charging request, the server transmits a charging authorization instruction to the specific electric vehicle charging station through the network, so that the specific electric vehicle charging station performs the charging operation. It should be noted that, in this embodiment, the server obtains the configuration setting data of the specific electric vehicle charging station, and determines that the specific user can use the specific electric vehicle charging station at the receiving time when the charging request is received according to the receiving time of receiving the charging request, the specific user category, and the configuration setting data of the specific electric vehicle charging station. Next, in step S860, the server continuously receives charging information from the specific electric vehicle charging station through the network during the execution of the charging operation. It is reminded that the charging information may at least include a charging time or a charging amount, but it is not limited thereto. During the charging operation, the server can know the charging amount or charging time of an electric vehicle that has been charged in the corresponding charging operation through the charging information.

In step S870, the server calculates a charging fee for the charging operation according to the charging information and the charging rate. Next, in step S880, the server accumulates the charging fee corresponding to the specific user, and in step S890, periodically provides a bill corresponding to the accumulated charging fee to the specific user to perform the periodic payment operation. In other words, in this embodiment, the charging fee related to a specific user will be collected and requested for payment periodically by the server. It is reminded that, similarly, the aforementioned periodic payment operation can be performed in a fixed period, such as weekly, monthly, quarterly, or yearly. The present invention is not limited to any period.

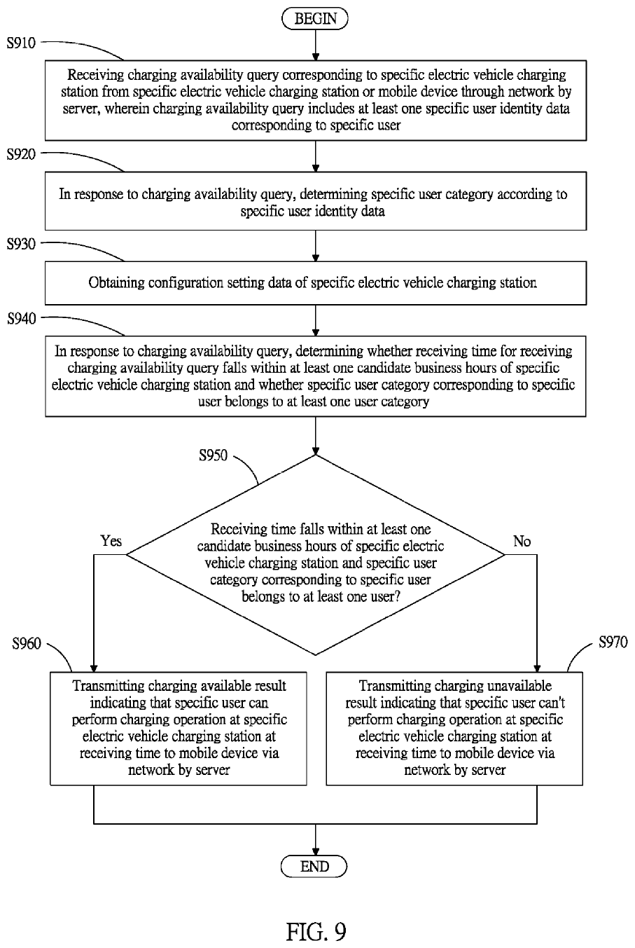

FIG. 9 is a flowchart of an embodiment of a method for determining whether a specific user can use a specific electric vehicle charging station of the invention. The method for determining whether the specific user can use the specific electric vehicle charging station of the invention is applicable to an electric vehicle charging station such as the specific electric vehicle charging station specified in the embodiment of FIG. 4 and a server. In this embodiment, the service application instruction can be a charging availability query, and the user may submit a charging availability query to the server to query whether the charging operation is currently available at the specific electric vehicle charging station.

First, in step S910, the server receives a charging availability query corresponding to the specific electric vehicle charging station from the specific electric vehicle charging station or a mobile device through the network. Note that the charging availability query includes at least one specific user identity data corresponding to a specific user. It is noted that, in some embodiments, the mobile device can use the application to scan the quick response code of the corresponding electric vehicle charging station or use an interface of the application to designate the corresponding electric vehicle charging station, so as to send the charging availability query corresponding to the specific electric vehicle charging station to the server through the network. It is reminded that the server can record the user identity data of each user and its corresponding user category. Next, in step S920, in response to the charging availability query, the server determines a specific user category according to the specific user identity data. Then, in step S930, the server obtains the configuration setting data of the specific electric vehicle charging station. It is noted that, the server may record the configuration setting data corresponding to each electric vehicle charging station, wherein the configuration setting data at least records at least one candidate business hours of each electric vehicle charging station, at least one user category provided for use during the candidate business hours, and whether the user category can make a reservation to use each electric vehicle charging station during the candidate business hours. After obtaining the configuration setting data of the specific electric vehicle charging station, in step S940, in response to the charging availability query, the server determines whether the receiving time for receiving the charging availability query falls within the at least one candidate business hours of the specific electric vehicle charging station and whether the specific user category corresponding to the specific user belongs to the at least one user category. When the receiving time falls within the at least one candidate business hours of the specific electric vehicle charging station, and the specific user category corresponding to the specific user belongs to the at least one user category (Yes in step S950), in step S960, the server transmits a charging available result to the mobile device via the network. The charging available result indicates that the specific user can perform a charging operation at the specific electric vehicle charging station at the receiving time. Contrarily, when the receiving time does not fall within any candidate business hours of the specific electric vehicle charging station, or when the specific user category corresponding to the specific user does not belong to at least one user category (No in step S950), in step S970, the server transmits a charging unavailable result to the mobile device via the network. The charging unavailable result indicates that the specific user cannot perform the charging operation at the specific electric vehicle charging station at the receiving time.

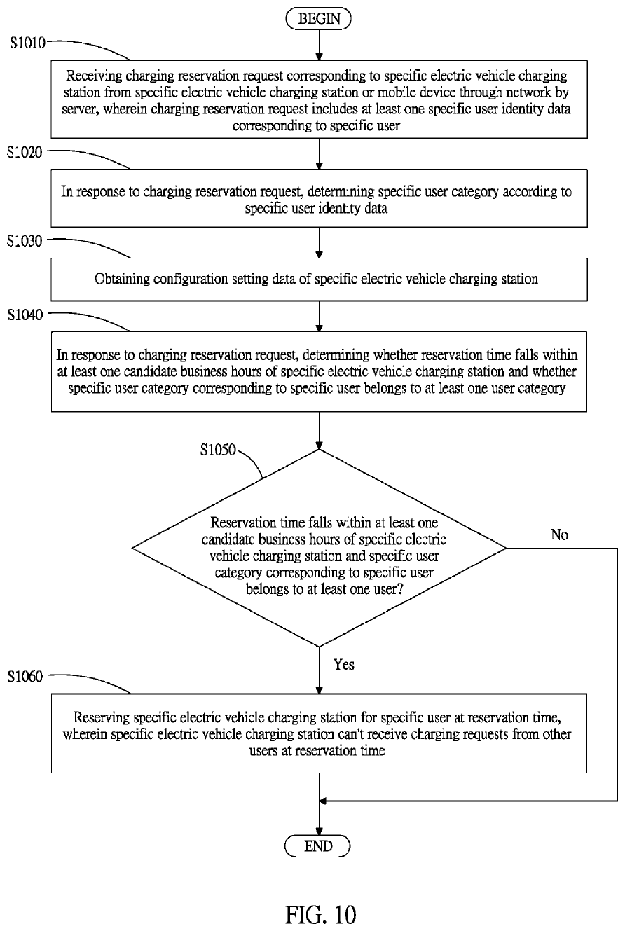

FIG. 10 is a flowchart of an embodiment of a method for determining whether a specific user can make a reservation on a specific electric vehicle charging station of the invention. The method for determining whether a specific user can make a reservation on a specific electric vehicle charging station of the invention is applicable to an electric vehicle charging station such as the specific electric vehicle charging station specified in the embodiment of FIG. 4 and a server. In this embodiment, the service application instruction can be a charging reservation request to allow the specific user to reserve the specific electric vehicle charging station at a specific reservation time, wherein the charging reservation request specifies the specific reservation time.

First, in step S1010, the server receives a charging reservation request corresponding to the specific electric vehicle charging station from the specific electric vehicle charging station or a mobile device through the network. Note that the charging reservation request includes at least one specific user identity data corresponding to a specific user. It is noted that, in some embodiments, the mobile device can use the application to scan the quick response code of the corresponding electric vehicle charging station or use an interface of the application to designate the corresponding electric vehicle charging station, so as to send the charging reservation request corresponding to the specific electric vehicle charging station to the server through the network. It is reminded that the server can record the user identity data of each user and its corresponding user category. Next, in step S1020, in response to the charging reservation request, the server determines a specific user category according to the specific user identity data. Then, in step S1030, the server obtains the configuration setting data of the specific electric vehicle charging station. It is noted that, the server may record the configuration setting data corresponding to each electric vehicle charging station, wherein the configuration setting data at least records at least one candidate business hours of each electric vehicle charging station, at least one user category provided for use during the candidate business hours, and whether the user category can make a reservation to use each electric vehicle charging station during the candidate business hours. After obtaining the configuration setting data of the specific electric vehicle charging station, in step S1040, in response to the charging reservation request, the server determines whether the reservation time falls within the at least one candidate business hours of the specific electric vehicle charging station and whether the specific user category corresponding to the specific user belongs to the at least one user category. When the reservation time does not fall within any candidate business hours of the specific electric vehicle charging station, or when the specific user category corresponding to the specific user does not belong to at least one user category (No in step S1050), it means that the specific user can't make a reservation on the specific electric vehicle charging station at the specified reservation time or the specific electric vehicle charging station can't provide reserved charging at the specified reservation time, and thus the process ends. When the reservation time falls within the at least one candidate business hours of the specific electric vehicle charging station, and the specific user category corresponding to the specific user belongs to the at least one user category (Yes in step S1050), in step S1060, the server reserves the specific electric vehicle charging station for the specific user at the reservation time, wherein the specific electric vehicle charging station can't receive charging requests from other users at the reservation time. In other words, only users of the specific user category can perform a charging reservation operation on the specific electric vehicle charging station in any candidate business hours of the specific electric vehicle charging station.

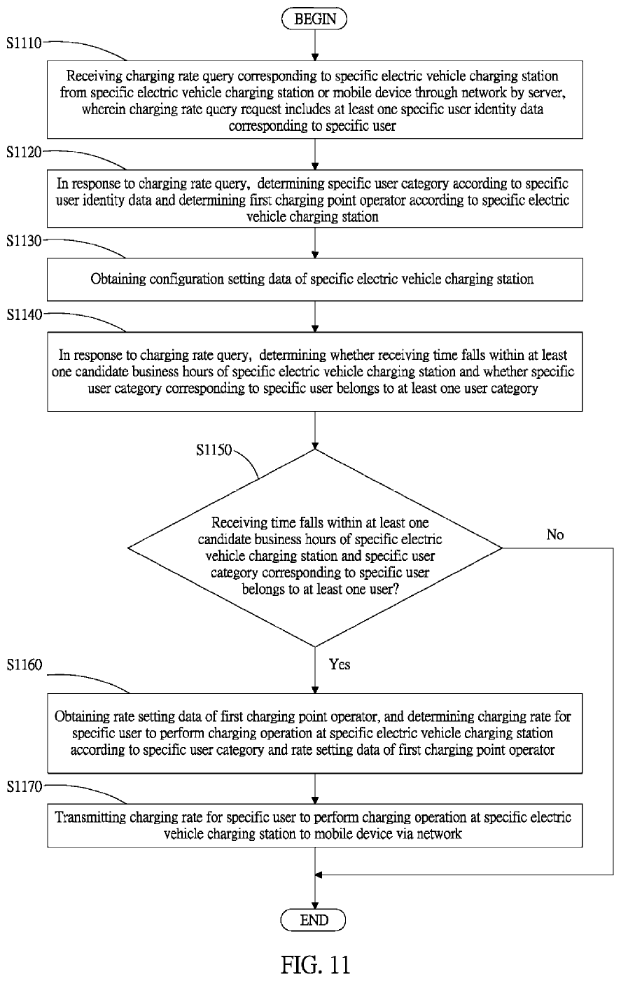

FIG. 11 is a flowchart of another embodiment of a method for multi-dimension electric vehicle charging management of the invention. The method for multi-dimension electric vehicle charging management of the invention is applicable to an electric vehicle charging station such as the specific electric vehicle charging station specified in the embodiment of FIG. 4 and a server. In this embodiment, the service application instruction may be a charging rate query and a specific user may query the charging rate at the specific electric vehicle charging station.

First, in step S1110, the server receives a charging rate query corresponding to the specific electric vehicle charging station from the specific electric vehicle charging station or a mobile device through the network. Note that the charging rate query may include at least one specific user identity data corresponding to a specific user. It is noted that, in some embodiments, the mobile device may designate the electric vehicle charging station by using the application to scan the quick response code corresponding to the electric vehicle charging station or through an interface of the application, so as to transmit the charging rate query corresponding to the electric vehicle charging station to the server via the network. It should be noted that, the server can record the user identity data of each user and its corresponding user category. Next, in step S1120, in response to the charging rate query, the server determines a specific user category according to the specific user identity data and determines a first charging point operator according to the specific electric vehicle charging station. Then, in step S1130, the server obtains the configuration setting data of the specific electric vehicle charging station. It is noted that, the server may record the configuration setting data corresponding to each electric vehicle charging station, wherein the configuration setting data at least records at least one candidate business hours of each electric vehicle charging station, at least one user category provided for use during the candidate business hours, and whether the user category can make a reservation to use each electric vehicle charging station during the candidate business hours. After obtaining the configuration setting data of the specific electric vehicle charging station, in step S1140, in response to the charging rate query, the server determines whether the receiving time for receiving the charging rate query falls within the at least one candidate business hours of the specific electric vehicle charging station and whether the specific user category corresponding to the specific user belongs to the at least one user category. When the receiving time does not fall within any candidate business hours of the specific electric vehicle charging station, or the specific user category corresponding to the specific user does not belong to the at least one user category (No in step S1150), the process ends. When the receiving time falls within at least one candidate business hours of the specific electric vehicle charging station, and the specific user category corresponding to the specific user belongs to the at least one user category (Yes in step S1150), in step S1160, the server obtains the rate setting data of the first charging point operator, and determines a charging rate for the specific user to perform a charging operation at the specific electric vehicle charging station according to the specific user category and the rate setting data of the first charging point operator, and in step S1170, transmits the charging rate for the specific user to perform the charging operation at the specific electric vehicle charging station to the mobile device corresponding to the specific user via the network. In other words, the user can obtain the charging rate corresponding to the charging field through the mobile device, and the charging rates obtained by the users with different identities are also different.

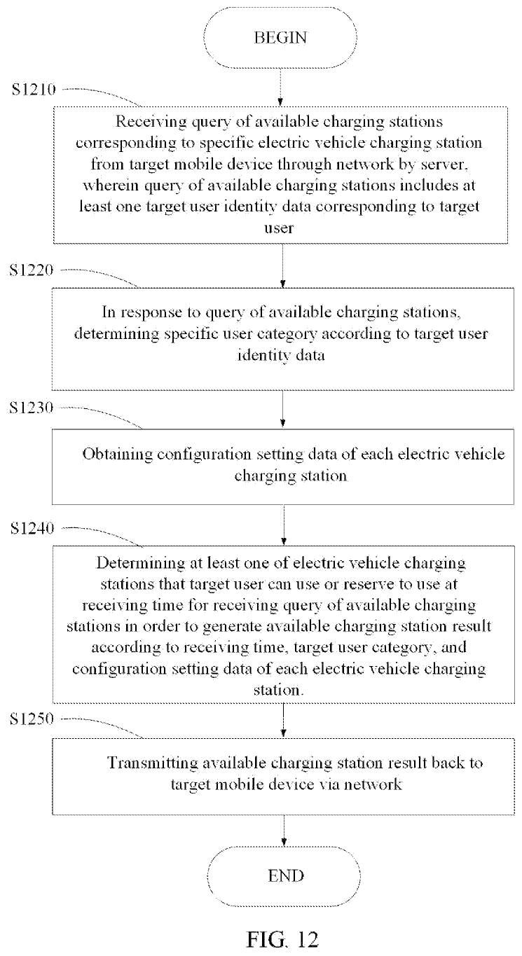

FIG. 12 is a flowchart of another embodiment of a method for multi-dimension electric vehicle charging management of the invention. The method for multi-dimension electric vehicle charging management of the invention is applicable to a server connected to a plurality of electric vehicle charging stations via a network. In this embodiment, the service application instruction can be a query of available charging stations and a specific user can request the query of available charging stations to the server to query electric vehicle charging stations that are currently available to use or available to be reserved.

First, in step S1210, the server receives a query of available charging stations from a target mobile device via the network, wherein the query of available charging stations at least comprises target user identity data corresponding to a target user. The mobile device or the application may correspond to a specific account, and the query of available charging stations at least includes information corresponding to the specific account. It should be noted that, in some embodiments, the mobile device may issue a query of available charging stations to the server through an interface of the application. It is noted that the server can record the user identity data of each user and respective user category and can record a receiving time of receiving the query of available charging stations. In step S1220, in response to the query of available charging stations, the server determines a target user category according to the target user identity data, and in step S1230, obtains the configuration setting data of each electric vehicle charging station. It is understood that the server can record the configuration setting data corresponding to each electric vehicle charging station, wherein the configuration setting data at least records at least one candidate business hours of each electric vehicle charging station, at least one user category provided for use during the candidate business hours, and whether the user category can make a reservation to use each electric vehicle charging station during the candidate business hours. After obtaining the configuration setting data corresponding to each electric vehicle charging station, in step S1240, the server determines at least one of the electric vehicle charging stations that the target user can use or reserve to use at a receiving time for receiving the query of available charging stations in order to generate an available charging station result according to the receiving time, the target user category, and the configuration setting data of each electric vehicle charging station. In other words, the available charging station result includes information about one or more available electric vehicle charging stations that the specific user can use or reserve to use at the receiving time. Thereafter, in step S1250, the server transmits the available charging station result back to the target mobile device via the network.

Therefore, methods and systems for multi-dimension electric vehicle charging management of the invention can integrate charging operations and charging rates and manage from different aspects such as electric vehicle charging stations, charging point operators, and users, so as to perform multi-dimensional electric vehicle charging, query and setting managements among electric vehicle charging stations, users, charging point operators, charging time and charging rates, thereby helping to reduce the difficulty of setting up and manage electric vehicle charging station, and increase the flexibility of the charging operation and rate management of electric vehicle charging stations for the managers of respective charging fields.

Methods for multi-dimension electric vehicle charging management may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for multi-dimension electric vehicle charging management, which is applicable to a server connected to a plurality of electric vehicle charging stations through a network, comprising:
providing configuration setting data corresponding to each electric vehicle charging station, wherein the configuration setting data at least records at least one candidate business hours of each electric vehicle charging station, at least one user category provided for use during the candidate business hours, and whether the user category can make a reservation to use each electric vehicle charging station during the candidate business hours;
receiving a service application instruction corresponding to a specific electric vehicle charging station among the electric vehicle charging stations or a mobile device through the network, wherein the service application instruction at least comprises specific user identity data corresponding to a specific user;
in response to the service application instruction, determining a corresponding specific user category based on the specific user identity data; and
obtaining the configuration setting data of the specific electric vehicle charging station, and determining whether the specific user can use or make a reservation to use the specific electric vehicle charging station at a receiving time at which the service application instruction is received according to the receiving time, the specific user category, and the configuration setting data of the specific electric vehicle charging station.

2. The method of claim 1, further comprising:
providing rate setting data corresponding to at least one charging point operator, wherein the rate setting data at least records a basic charging rate and a discount rate corresponding to the at least one user category;
in response to the service application instruction, determining a first charging point operator according to the specific electric vehicle charging station; and
obtaining the rate setting data of the first charging point operator, and determining a charging fee for the specific user to perform a charging operation at the specific electric vehicle charging station according to the specific user category and the rate setting data of the first charging point operator.

3. The method of claim 2, wherein the service application instruction is a charging request, and the method further comprises:
in response to the charging request, transmitting a charging authorization instruction to the specific electric vehicle charging station through the network, so that the specific electric vehicle charging station performs the charging operation; and
during the execution of the charging operation, continuously receiving charging information from the specific electric vehicle charging station via the network.

4. The method of claim 3, further comprising:
calculating a charging fee for the charging operation according to the charging information and the charging rate;
determining whether the specific user category is a second charging point operator; and
when the specific user category is the second charging point operator, accumulating the charging fee corresponding to the specific user and periodically providing a bill corresponding to the accumulated charging fee to the specific user through the second charging point operator.

5. The method of claim 3, further comprising:
calculating a charging fee for the charging operation according to the charging information and the charging rate;
accumulating the charging fee corresponding to the specific user; and
periodically providing a bill corresponding to the accumulated charging fee to the specific user. cm 6. The method of claim 1, wherein the service application instruction is a charging availability query and the method further comprises:
in response to the charging availability query, determining whether the receiving time falls within the at least one candidate business hours of the specific electric vehicle charging station and whether the specific user category corresponding to the specific user belongs to the at least one user category; and
transmitting a charging available result to the mobile device via the network when the receiving time falls within the at least one candidate business hours of the specific electric vehicle charging station and the specific user category corresponding to the specific user belongs to the at least one user category, wherein the charging available result indicates that the specific user can perform the charging operation at the specific electric vehicle charging station at the receiving time.

7. The method of claim 2, wherein the service application instruction is a charging rate query, and the method further comprises:
in response to the charging rate query, determining whether the receiving time falls within the at least one candidate business hours of the specific electric vehicle charging station and whether the specific user category corresponding to the specific user belongs to the at least one user category; and
transmitting the charging rate for the specific user to perform the charging operation at the specific electric vehicle charging station to the mobile device via the network when the receiving time falls within the at least one candidate business hours of the specific electric vehicle charging station and the specific user category corresponding to the specific user belongs to the at least one user category.

8. The method of claim 1, wherein the service application instruction is a charging reservation request specifying a reservation time, and the method further comprises:
in response to the charging reservation request, determining whether the reservation time falls within the at least one candidate business hours of the specific electric vehicle charging station and whether the specific user category corresponding to the specific user belongs to the at least one user category; and
when the reservation time falls within the at least one candidate business hours of the specific electric vehicle charging station and the specific user category corresponding to the specific user belongs to the at least one user category, reserving the specific electric vehicle charging station for the specific user at the reservation time,
wherein the specific electric vehicle charging station cannot receive charging requests from other users at the reservation time.

9. The method of claim 1, further comprising:
receiving a query of available charging stations from a target mobile device via the network, wherein the query of available charging stations at least comprises target user identity data corresponding to a target user;
in response to the query of available charging stations, determining a target user category according to the target user identity data;
obtaining the configuration setting data of each electric vehicle charging station;
determining at least one of the electric vehicle charging stations that the target user can use or reserve to use at a receiving time for receiving the query of available charging stations in order to generate an available charging station result according to the receiving time, the target user category, and the configuration setting data of each electric vehicle charging station; and
transmitting the available charging station result back to the target mobile device via the network.

10. A system for multi-dimension electric vehicle charging management, comprising:
an electric vehicle charging equipment;
which is applicable to a server connected to a plurality of electric vehicle charging stations through a network, comprising:
a mobile device corresponding to a specific user;
a plurality of electric vehicle charging stations, each electric vehicle charging station having a network connection capability; and
a server connected to each electric vehicle charging station through a network, recording configuration setting data corresponding to each electric vehicle charging station, wherein the configuration setting data at least records at least one candidate business hours of each electric vehicle charging station, at least one user category provided for use during the candidate business hours and whether the user category can make a reservation to use each electric vehicle charging station during the candidate business hours, receiving a service application instruction corresponding to a specific electric vehicle charging station among the electric vehicle charging stations or a mobile device through the network, wherein the service application instruction at least comprises specific user identity data corresponding to a specific user, and in response to the service application instruction, determining a specific user category based on the specific user identity data and obtaining the configuration setting data of the specific electric vehicle charging station, and determining whether the specific user can use or make a reservation to use the specific electric vehicle charging station at a receiving time at which the service application instruction is received according to the receiving time, the specific user category, and the configuration setting data of the specific electric vehicle charging station.

11. The system of claim 10, wherein the server further provides rate setting data corresponding to at least one charging point operator, wherein the rate setting data at least records a basic charging rate and a discount rate corresponding to the at least one user category, determines a first charging point operator according to the specific electric vehicle charging station in response to the service application instruction, and obtains the rate setting data of the first charging point operator, and determining a charging fee for the specific user to perform a charging operation at the specific electric vehicle charging station according to the specific user category and the rate setting data of the first charging point operator.

12. The system of claim 11, wherein the service application instruction is a charging request, and the server further transmits a charging authorization instruction to the specific electric vehicle charging station through the network in response to the charging request, so that the specific electric vehicle charging station performs the charging operation and continuously receives charging information from the specific electric vehicle charging station via the network during the execution of the charging operation,

13. The system of claim 12, wherein the server further calculates a charging fee for the charging operation according to the charging information and the charging rate, determines whether the specific user category is a second charging point operator, and accumulates the charging fee corresponding to the specific user and periodically providing a bill corresponding to the accumulated charging fee to the specific user through the second charging point operator when the specific user category is the second charging point operator.

14. The system of claim 12, wherein the server further calculates a charging fee for the charging operation according to the charging information and the charging rate, accumulates the charging fee corresponding to the specific user, and periodically provides a bill corresponding to the accumulated charging fee to the specific user.

15. The system of claim 10, wherein the service application instruction is a charging availability query and in response to the charging availability query, the server further determines whether the receiving time falls within the at least one candidate business hours of the specific electric vehicle charging station and whether the specific user category corresponding to the specific user belongs to the at least one user category, and transmits a charging available result to the mobile device via the network when the receiving time falls within the at least one candidate business hours of the specific electric vehicle charging station and the specific user category corresponding to the specific user belongs to the at least one user category, wherein the charging available result indicates that the specific user can perform the charging operation at the specific electric vehicle charging station at the receiving time.

16. The system of claim 11, wherein the service application instruction is a charging rate query, and in response to the charging rate query, the server further determines whether the receiving time falls within the at least one candidate business hours of the specific electric vehicle charging station and whether the specific user category corresponding to the specific user belongs to the at least one user category, and transmits the charging rate for the specific user to perform the charging operation at the specific electric vehicle charging station to the mobile device via the network when the receiving time falls within the at least one candidate business hours of the specific electric vehicle charging station and the specific user category corresponding to the specific user belongs to the at least one user category.

17. The system of claim 10, wherein the service application instruction is a charging reservation request specifying a reservation time, and in response to the charging reservation request, the server further determines whether the reservation time falls within the at least one candidate business hours of the specific electric vehicle charging station and whether the specific user category corresponding to the specific user belongs to the at least one user category, and reserves the specific electric vehicle charging station for the specific user at the reservation time when the reservation time falls within the at least one candidate business hours of the specific electric vehicle charging station and the specific user category corresponding to the specific user belongs to the at least one user category, wherein the specific electric vehicle charging station cannot receive charging requests from other users at the reservation time.

18. The system of claim 10, wherein the server further receives a query of available charging stations from a target mobile device via the network, wherein the query of available charging stations at least comprises target user identity data corresponding to a target user, and in response to the query of available charging stations, the server further determines a target user category according to the target user identity data, obtains the configuration setting data of each electric vehicle charging station, determines at least one of the electric vehicle charging stations that the target user can use or reserve to use at a receiving time for receiving the query of available charging stations in order to generate an available charging station result according to the receiving time, the target user category, and the configuration setting data of each electric vehicle charging station, and transmits the available charging station result back to the target mobile device via the network.

19. A machine-readable storage medium comprising a computer program, which, when executed, causes a device to perform a method for multi-dimension electric vehicle charging management, which is applicable to a server connected to a plurality of electric vehicle charging stations through a network, wherein the method comprises:
providing configuration setting data corresponding to each electric vehicle charging station, wherein the configuration setting data at least records at least one candidate business hours of each electric vehicle charging station, at least one user category provided for use during the candidate business hours, and whether the user category can make a reservation to use each electric vehicle charging station during the candidate business hours;
receiving a service application instruction corresponding to a specific electric vehicle charging station among the electric vehicle charging stations or a mobile device through the network, wherein the service application instruction at least comprises specific user identity data corresponding to a specific user;
in response to the service application instruction, determining a corresponding specific user category based on the specific user identity data; and
obtaining the configuration setting data of the specific electric vehicle charging station, and determining whether the specific user can use or make a reservation to use the specific electric vehicle charging station at a receiving time at which the service application instruction is received according to the receiving time, the specific user category, and the configuration setting data of the specific electric vehicle charging station.
